(19) United States
(12) Patent Application Publication
(10) Pub. No.: US 2003/0010176 A1
(43) Pub. Date: Jan. 16, 2003

(54) Downward pressure structure for punching machine

(76) Inventor: Tom Chiang, Tou Liu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/903,648

(22) Filed: Jul. 13, 2001

(51) Int. Cl. B26D 5/08

(52) U.S. Cl. 83/618; 83/613

(57) ABSTRACT

A downward pressing structure for punching machine comprises a pressure handle, at least two linking posts, a restoring spring, a cutter plate and a machine base, wherein, the machine base has a perpendicular plate having pivoted bolts. The cutter plate comprises cutter heads extending from the lower end, and vertical sliding slots on top portion for insertion of the pivoted bolts, thus, the cutter plate slides up and down there along the machine base. Each linking post has one end pivoted to the machine base, and an adjacent portion with respect to the end pivoted to the cutter plate, and whereas the other end of each linking post is pivoted to the pressure handle. The restoring spring has its two ends pivoted to the pressure handle and the machine base, respectively.

### BACKGROUND OF THE INVENTION

1. Field of the Invention

The invention herein relates to a downward pressure structure for punching machine, more particularly to a pressure handle connected to slanting linking posts, which drives a cutter plate to punch holes.

2. Description of the Prior Art

The cutter plate set of a conventional punching machine uses a long handle to control a revolving shaft to drive the cutter plate set to punch holes, this design saves users' energy, however, owing to the long handle is in a slanting status with the handle protruding away from one side of the machine base, it not only takes much space, but also may injure a passersby, accidentally.

The inventor has invented this new design, which makes improvements towards the above-mentioned and many other shortcomings.

### SUMMARY OF THE INVENTION

The main object of the present invention is to provide a downward pressing structure for punching machine, which includes a pressure handle, at least two linking posts, a restoring spring, a cutter plate and a machine base, wherein, the machine base has a perpendicular plate with pivoted bolts and the cutter plate comprises cutter heads extending from the lower end thereof and sliding slots on the top portion to receive the pivoted bolts therein so that the cutter plate is able to slide with respect to the machine base. Each linking post has one end pivoted to the machine base with an adjacent portion pivoted to the cutter plate, the other end of each linking post is pivoted to the pressure handle. The restoring spring has its two ends connected to the pressure handle and the machine base, respectively, whereas by pressing the pressure handle, the linking posts will be driven, which in turn links the cutter plate to slide downward. When releasing the pressure handle, the restoring spring urges the pressure handle, linking posts, and the cutter plate to its original position. This design is safe in use and takes less space, and easy to operate.

### BRIEF DESCRIPTION OF THE DRAWINGS

FIG. 1 is an exploded view of the present invention;

FIG. 2 is a front view of the present invention, before operation; and

FIG. 3 is a view similar to FIG. 2, in an operation status.

### DETAILED DESCRIPTION OF THE PREFERRED EMBODIMENTS

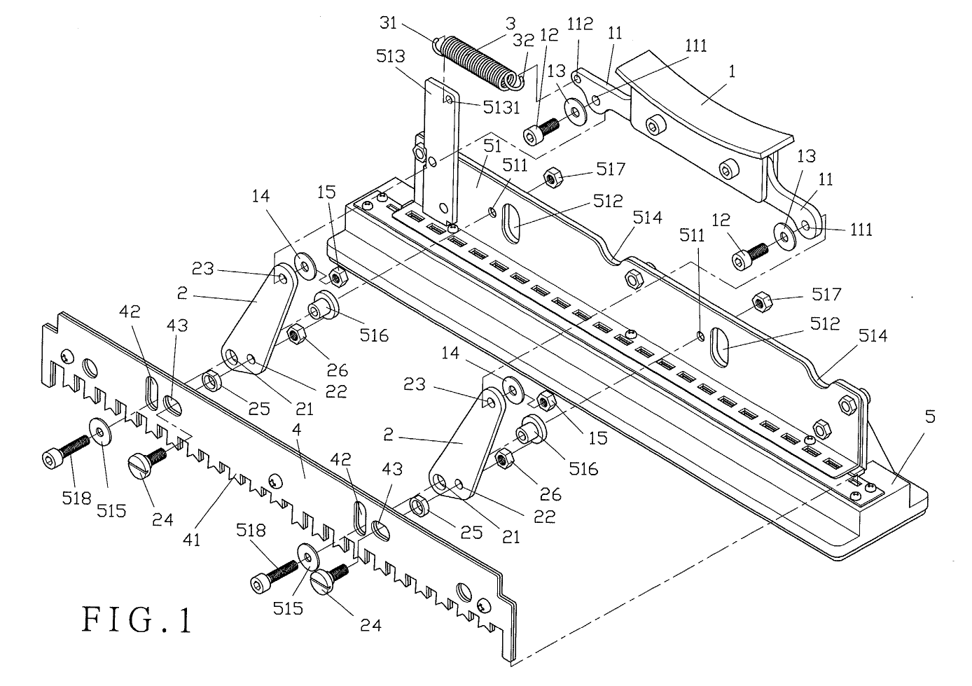

As shown in FIG. 1, the present invention comprises a pressure handle (1), linking posts (2), a restoring spring (3), a cutter plate (4), and a machine base (5).

The pressure handle (1) extends a pair of lugs (11) from respective ends (They could be directly two ends of the pressure handle (1)). Each of the lugs (11) has a threaded hole (111) relative to a bolt (12), a pair of washers (13), (14) and a nut (15). One of the lugs (11) has a second hole (112).

There are at least two linking posts. Each of the linking posts (2) has two adjacent holes (21) and (22) at one end, and a single hole (23) at the other end thereof The arrangement of the two adjacent holes (21) (22) is that the hole (22) is on the upper diagonal side of the other hole (21). There are a bolt (24), a washer (25), and a nut (26) relative to the hole (21).

The restoring spring (3) comprises a pair of retaining hooks (31), (32) at respective ends thereof.

The cutter plate (4) comprises cutter heads (41) extending from the lower end, vertical sliding slots (42) corresponding to the holes (21) of the linking posts (2), horizontal sliding slots (43) next to one side of the sliding slots (42). The horizontal sliding slots (43) are relative to the holes (22) of the linking posts (2).

The machine base (5) has a perpendicular plate (51) having holes (511) corresponding to the holes (21) of the linking posts (2). Next to the holes (511) are vertical sliding slots (512) corresponding to the holes (22) of the linking posts (2). One end of the perpendicular plate (51) has a protuberance (513) and the top end of the protuberance (513) has a hole (5131). There are a plural recesses (514) on the top portion of the perpendicular plate (51), which serves as a retainer for the movement of the pressure handle (1) (to engage a nut (15)). The machine base (5) further comprises bolts (518), washers (515), T-shaped sleeves (516), and nuts (517) relative to the sliding slots (42), the holes (21) and the holes (511).

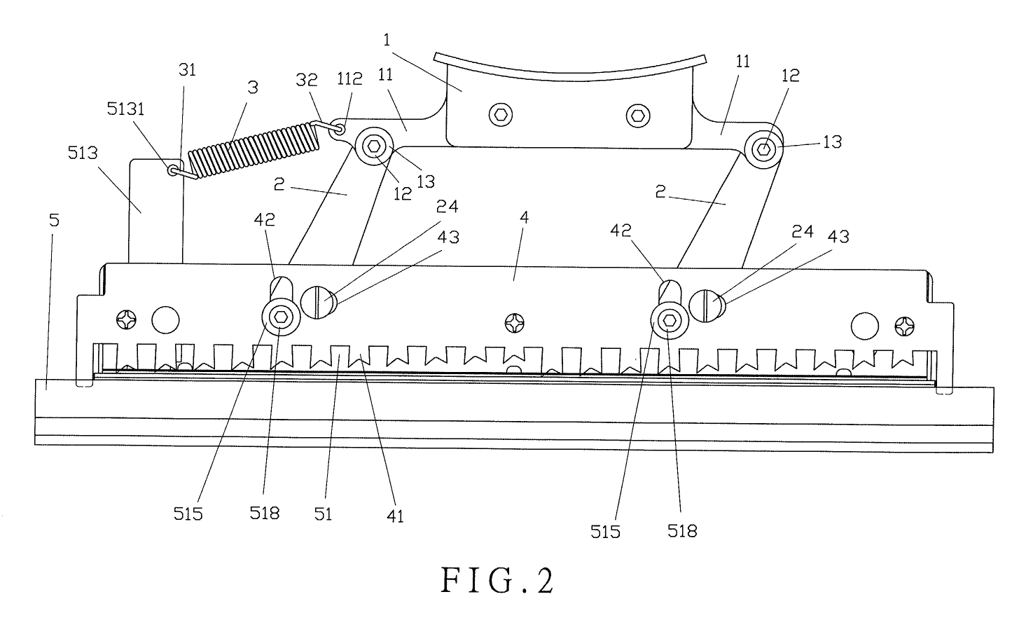

To assembly, refer to FIG. 2, each of the bolts (12) is inserted through the washer (13), the hole (23), the hole (111), and the washer (14), and fastened by the nut (15) from the other side, thus, the upper end of the linking post (2) is secured to the lug (11) of the pressure handle (1) [or directly connected to the pressure handle (1)]. Each of the bolts (24) is inserted through the sliding slot (43), the washer (25), and the hole (22), and is secured by the nut (26). This design allows the washer (25) to slide within the sliding slot (43), and the linking post (2) to drive the cutter plate (4), simultaneously. The retaining hooks (31) (32) at two ends of the restoring spring (3) are secured in the holes (112) and (5131), thus, the two ends of the restoring spring (3) are secured to the lug (11) of the pressure handle (1) and the protuberance (513) of the perpendicular plate (51) of the machine base (5) for pulling the pressure handle (1) toward the protuberance (513) of the perpendicular plate (51). Each of the sleeves (516) is inserted through the hole (21) and the sliding slot (42), and then the bolt (518) is inserted through the washer (515), the sleeve (516), the hole (511), and fastened by the nut (517). By the bolt (518) and the sleeve (516), the lower end of the linking post (2) is pivoted to the machine base (5), and the cutter plate (4) is confined to move upward and downward by the sleeve (516). After assembly, as shown in FIG. 2, the linking post (2) remains in a slanting status and in an angle.

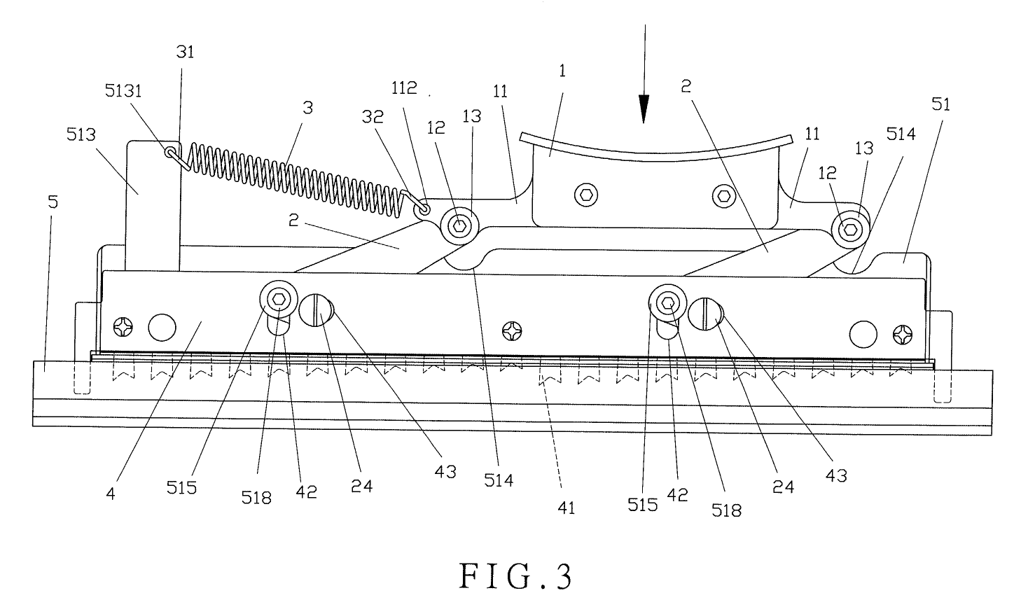

FIG. 3 shows the punching machine in an operation status, by pressing the pressure handle (1), the linking posts (2) will be driven, which links the bolts (24) [with the washers (25)] to press the cutter plate (4) downwards, and because of the sliding slots (42) are restrained by the sleeves (516), it will also move downwards to punch holes. When the pressure handle (1) is released, the restoring spring (3) will immediately urge the pressure handle (1), the linking posts (2) and the cutter plate (4) to its original position.

In summation of the foregoing said, this invention uses a pressure handle (1) to drive the slanting linking posts (2), which in turn links the cutter plate (4), this design is safe in use and it saves much space and the operation is direct and easy.

1. wherein each of said linking posts has one end pivoted to said pivoted bolts of said perpendicular plate of said machine base, and one side of each said sliding slot of said cutter plate is pivoted to said linking post.
